(19) United States
(12) Patent Application Publication
(10) Pub. No.: US 2017/0024843 A1
(43) Pub. Date: Jan. 26, 2017

(54) METHOD AND DEVICE FOR REMOVING VIDEO WATERMARKS

(71) Applicants: LE HOLDINGS (BEIJING) CO., LTD., Beijing (CN); LECLOUD COMPUTING CO., LTD., Beijing (CN)

(72) Inventors: Yang LIU, Beijing (CN); Wei WEI, Beijing (CN); Maosheng BAI, Beijing (CN); Yangang CAI, Beijing (CN); Hai QI, Beijing (CN)

(73) Assignees: LE HOLDINGS (BEIJING) CO., LTD., Beijing (CN); LECLOUD COMPUTING CO., LTD., Beijing (CN)

(21) Appl. No.: 15/242,339

(22) Filed: Aug. 19, 2016

Related U.S. Application Data
(63) Continuation of application No. PCT/CN2016/083055, filed on May 23, 2016.

(30) Foreign Application Priority Data
Jul. 24, 2015 (CN) 201510441679.2

(51) Int. Cl. G06T 1/00; G06T 7/00; G06T 5/00

(52) U.S. Cl. CPC G06T 1/0021; G06T 5/004; G06T 7/0081; G06T 2207/20021

(57) ABSTRACT

The embodiment of the present disclosure provides a method for removing video watermarks, wherein the method includes: finding out a watermark region in a video and selecting a proper watermark expansion region, and copying the pixels of the watermark expansion region to form a mask region; extending the watermark region in an original video frame to form a stuffing region, and using pixels beside the stuffing region to stuff the watermark region to acquire a video frame after stuffing; and performing blur processing on the mask region, and finally superposing the video frame after stuffing with the mask region after blur processing, thus being capable of removing the watermarks completely, and ensuring the smooth transition between the watermark-removed region and a surrounding region in the meanwhile

### CROSS-REFERENCE TO RELATED DISCLOSURES

This application is a continuation application of PCT international application No. PCT/CN2016/083055, filed May 23, 2016, which claims priority to Chinese Patent Application No. 201510441679.2, filed Jul. 24, 2015. The entire contents of these applications are incorporated herein by reference.

### TECHNICAL FIELD

The embodiments of the present disclosure relate to the field of video technologies, and, more particularly, to a method and a device for removing video watermarks.

### BACKGROUND

A large number of video files are produced in the era of rapid development of multimedia technologies. In some video files, producers will label these videos using watermarks sometimes for the purposes of advertising or protecting the video copyrights and tracing infringing acts, or the like. However, these videos labeled with the watermarks will often reduce the viewing experience of viewers; moreover, video spreaders do not expect to spread the watermarks of others as a part of video contents while spreading the videos. Therefore, a technology for removing video watermarks is produced for video processing.

The watermark removing technologies at present mainly include the several types, wherein the first technology is to simply use pixels outside a watermark region to replace all the pixels inside the watermark region. This method can remove the watermarks, but such characteristics like quite apparent and larger color change, or the like, exist between a shading region produced and a surrounding frame, so that the shaded watermark region becomes very abrupt and has a significant impact on the viewing effects. A second technology is to perform blur processing on the watermark region, so that the watermark becomes blurred and cannot be seen clearly. This method can ensure the smooth transition between the shading region and the surrounding frame on a certain degree; however, because it is blur processing only, the pattern of the watermark is faintly visible and cannot be removed thoroughly when the blur degree is small. While the smooth transition cannot be ensured when the blur degree is large.

The embodiments of the present disclosure provide a new method which not only can remove the watermarks completely, but also can ensure the smooth transition between the watermark-removed region and the surrounding region.

### SUMMARY

The embodiments of the present disclosure provide a method and a device for removing video watermarks, for solving the problems in the prior art that the watermarks cannot be thoroughly removed or the smooth transition of the frame cannot be ensured.

In order to implement the foregoing objects, the embodiments of the present disclosure employ the following technical solutions.

According to a first aspect, it provides a method for removing video watermarks, including:

selecting a rectangle region containing watermarks in a video frame as a watermark region and selecting a watermark expansion region, wherein the watermark expansion region is selected by externally extending the four sides of the watermark region to a first pixel range;

copying all the pixels inside the watermark expansion region, and regarding a region formed by the pixels copied as a mask region;

externally extending the four sides of the watermark region to a second pixel range to form a stuffing region in the video frame, and using pixel values on the four sides of the stuffing region to stuff all the regions inside the watermark region to form a stuffed video frame, wherein the second pixel range is less than the first pixel range;

performing blur processing on the mask region; and

superposing the mask region after blur processing to the corresponding position of the stuffed video frame according to the position of the watermark expansion region in the video frame.

According to a second aspect, it provides a computer-readable recording medium recording a program configured to conduct the above described method.

According to a third, it provides a device for removing video watermarks, including:

a region selection module configured to select a rectangle region containing watermarks in a video frame as a watermark region and also configured to select a watermark expansion region in the video frame and copy all the pixels inside the watermark expansion region, and regard a region formed by the pixels copied as a mask region, wherein the watermark expansion region is selected by externally extending the four sides of the watermark region to a first pixel range;

a watermark stuffing module configured to externally extend the four sides of the watermark region to a second pixel range to form a stuffing region in the video frame, and use pixel values on the four sides of the stuffing region to stuff all the regions inside the watermark region to form a stuffed video frame;

a blur processing module configured to perform blur processing on the mask region; and

a superposition module configured to superpose the mask region after blur processing to the corresponding position of the stuffed video frame according to the position of the watermark expansion region in the video frame.

### BRIEF DESCRIPTION OF THE DRAWINGS

In order to explain the technical solutions in the embodiments of the present disclosure or in the prior art more clearly, the drawings used in the descriptions of the embodiments or the prior art will be simply introduced hereinafter. It is apparent that the drawings described hereinafter are merely some embodiments of the present disclosure, and those skilled in the art may also obtain other drawings according to these drawings without going through creative work.

FIG. 1 is a technical flow chart of a first embodiment of the present disclosure;

FIG. 2 is a technical flow chart of a second embodiment of the present disclosure;

FIG. 3 is a schematic diagram illustrating watermarks in a stuffing region of the embodiment of the present disclosure;

FIG. 4 is a technical flow chart of a fourth embodiment of the present disclosure;

FIG. 5 is a schematic diagram of a mask region of the embodiment of the present disclosure;

FIG. 6 is a schematic diagram for calculating a superposing parameter during a superposition process of the embodiment of the present disclosure;

FIG. 7 is a structural diagram of a device according to a fifth embodiment of the present disclosure;

FIG. 8 is a schematic diagram for filling an disclosure scenario of the embodiment of the present disclosure; and

FIG. 9 is a schematic diagram for superposing the disclosure scenario of the embodiment of the present disclosure.

### PREFERRED EMBODIMENTS

To make the objects, technical solutions and advantages of the embodiments of the present disclosure more clearly, the technical solutions of the present disclosure will be clearly and completely described hereinafter with reference to the embodiments and drawings of the present disclosure. Apparently, the embodiments described are merely partial embodiments of the present disclosure, rather than all embodiments. Other embodiments figured out by those having ordinary skills in the art on the basis of the embodiments of the present disclosure without going through creative efforts shall all fall within the protection scope of the present disclosure.

### First Embodiment

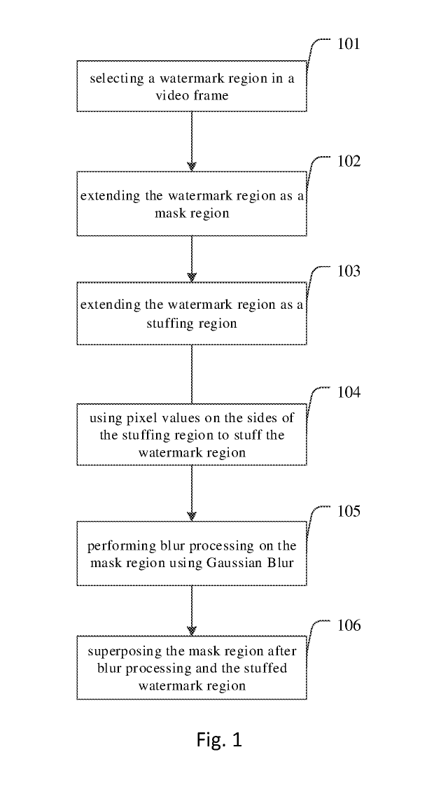

As shown in FIG. 1, a method for removing video watermarks in the embodiment of the present disclosure includes the following steps.

In step 101: a rectangle region containing watermarks in a video frame is selected as a watermark region.

Because the watermark positions are generally fixed in one video, the selection of the watermark region may be completed manually by framing the rectangle region using a mouse according to the position of the watermark in the video frame.

In step 102: a watermark expansion region is selected in the video frame, all the pixels inside the watermark expansion region are copied, and a region formed by the pixels copied is regard as a mask region, wherein the watermark expansion region is selected by externally extending the four sides of the watermark region to a first pixel range.

In step 103: the four sides of the watermark region are externally extended to a second pixel range to form a stuffing region in the video frame.

In step 104: pixel values on the four sides of the stuffing region are used to stuff all the regions inside the watermark region to form a stuffed video frame.

In step 105: blur processing is performed on the mask region.

The blur processing is a smoothing technology in image processing. In the embodiment of the present disclosure, Gaussian Blur which is also called as Gaussian Smoothing is adopted, which is a processing effect widely used in image processing software, and is usually used for decreasing image noises and reducing the level of details.

In step 106: the mask region after blur processing is superposed to the corresponding position of the stuffed video frame according to the position of the watermark expansion region in the video frame.

Wherein, the second pixel range is less than the first pixel range.

### Second Embodiment

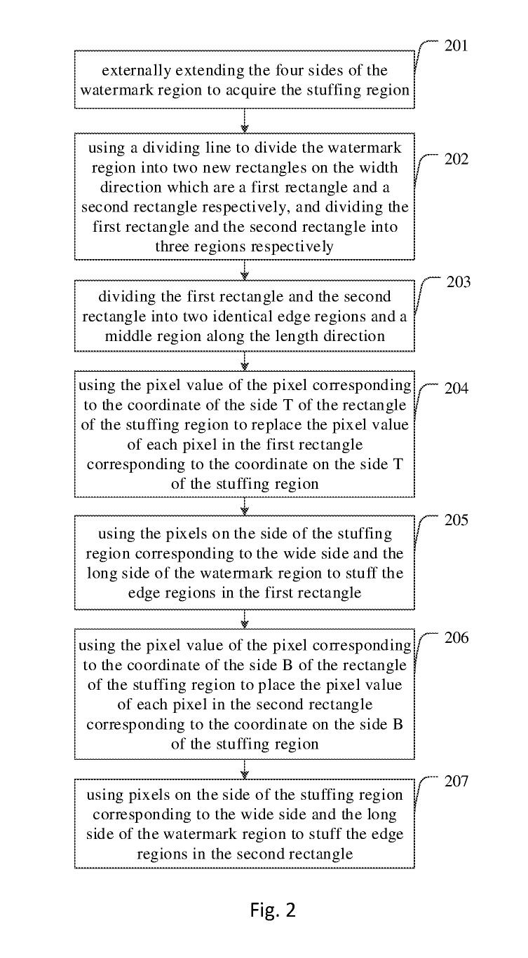

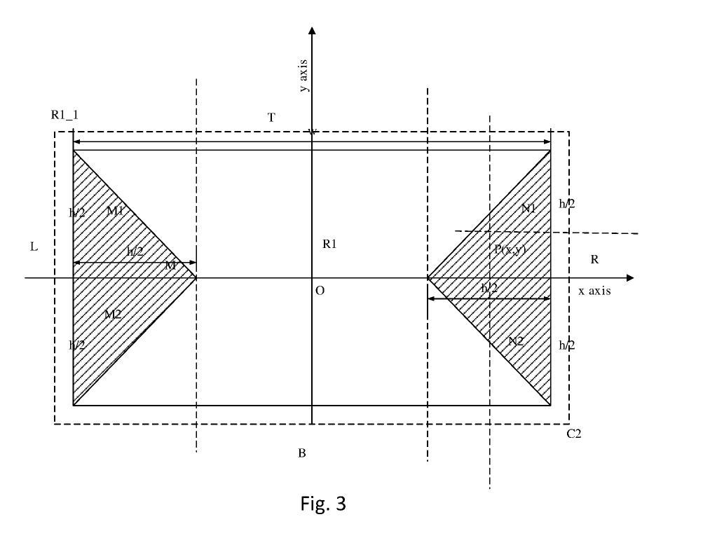

According to FIG. 2, in the method for removing video watermarks according to the embodiment of the present disclosure, the four sides of the watermark region are externally extended to the second pixel range to form the stuffing region in the video frame, and the pixel values on the four sides of the stuffing region are used to stuff all the regions inside the watermark region to form the stuffed video frame. An example for extending and dividing the watermark region is as shown in FIG. 3, which further includes the following steps.

In step 201: the externally extending the four sides of the watermark region to the second pixel range to form the stuffing region further includes three methods as follows.

In step 201a: the side T of the watermark region is upwards extended to the second pixel range, the side B of the watermark region is downwards extended to the second pixel range in the meanwhile, and the new height after extending is used as the base to extend the side L of the watermark region to the second pixel range to the left, and the new height after extending is used as the base to extend the side R of the watermark region to the second pixel range to the right in the meanwhile to acquire the rectangular stuffing region.

In step 201b: in the embodiment of the present disclosure, the side L of the watermark region may be extended to the second pixel range to the left, and the side R of the watermark region is extended to the second pixel range to the right in the meanwhile, and the new height after extending is used as the base to upwards extend the side T of the watermark region to the second pixel range, and downwards extend the side B of the watermark region to the second pixel range in the meanwhile to acquire the rectangular stuffing region.

In step 201c: in the embodiment of the present disclosure, the ordinates and abscissas of the four end points of the rectangle of the watermark region may be externally changed to the second pixel range at the same time along the diagonal line of the rectangle to acquire the stuffing region in the center of the rectangle of the watermark region, i.e., it is provided that the central point of the rectangle of the watermark region is taken as the origin of coordinates, and the four end points of the rectangle of the watermark region are respectively: P(x₁, y₁), P(x₂, y₂), P(x₃, y₃) and P(x₄, y₄), wherein the end points of the stuffing region acquired after externally changing along the stuffing region are P(x₁−1, y₁+1), P(x₂−1, y₂−1), P(x₃+1, y₃+1) and P(x₄+1, y₄−1).

The three methods for externally extending the four sides of the watermark region to the second pixel range to form the stuffing region are illustrated in the step of the embodiment of the present disclosure, but the present disclosure is not limited to the three methods mentioned above.

In step 202: a dividing line is used to divide the watermark region into two new rectangles on the width direction which are a first rectangle and a second rectangle respectively, wherein the widths of the first rectangle and the second rectangle are equal to a half of the width of the watermark region.

In step 203: the first rectangle and the second rectangle are divided into two identical edge regions and a middle region along the length direction, wherein each of the edge regions has a side superposed with sides of the watermark region with different widths respectively, and the middle region has a side superposed with the long side of the watermark region. In the embodiment of the present disclosure, it is stipulated that the sides corresponding to the length of the watermark region are side T and side B, while the sides corresponding to the width of the watermark region are side L and side R.

The first rectangle includes three regions, which are a first edge region, a second edge region and a first middle region respectively, wherein the first edge region is a first equilateral right triangle region in the first rectangle, a half of the height of the watermark region is used as the base and height of the first equilateral right triangle region, the height of the first equilateral right triangle region is superposed with the side L of the watermark region, and the base of the first equilateral right triangle region is superposed with the dividing line.

The second edge region is a second equilateral right triangle region in the first rectangle, a half of the height of the watermark region is used as the base and height of the second equilateral right triangle region, the height of the second equilateral right triangle region is superposed with the side R of the watermark region, and the base of the second equilateral right triangle region is superposed with the dividing line.

The first middle region is a region in the first rectangle excluding the first equilateral right triangle region and the second equilateral right triangle region, and the shape of the first middle region is not limited to an isosceles trapezoid or an isosceles triangle.

The second rectangle is divided into three regions, which are a third edge region, a fourth edge region and a second middle region respectively.

The third edge region is a third equilateral right triangle region in the second rectangle, a half of the height of the watermark region is used as the base and height of the third equilateral right triangle region, the height of the third equilateral right triangle region is superposed with the side L of the watermark region, and the base of the third equilateral right triangle region is superposed with the dividing line.

The fourth edge region is a fourth equilateral right triangle region in the second rectangle, a half of the height of the watermark region is used as the base and height of the fourth equilateral right triangle region, the height of the fourth equilateral right triangle region is superposed with the side R of the watermark region, and the base of the fourth equilateral right triangle region is superposed with the dividing line.

The second middle region is a region in the second rectangle excluding the third equilateral right triangle region and the fourth equilateral right triangle region, and the shape of the second middle region is not limited to an isosceles trapezoid or an isosceles triangle.

As shown in FIG. 3, 1 is used as the second pixel range in the embodiment of the present disclosure, for the watermark region R1, it is given that the width of the region R1 is w, and the height thereof is h. The watermark region R1 is used as a base to externally extend one pixel to form a new rectangle region, which is namely the stuffing region R1_1. It is given that the four sides of the region R1_1 are L, R, T and B respectively, wherein the lengths of the L and R are h+2, while the lengths of T and B are w+2.

The region R1 is divided into two portions on the height direction, and the height of each portion is h/2, as shown in FIG. 3.

Further, the two sides L and R of the first rectangle are respectively used as one side in the first rectangle, and the other side is superposed with a horizontal dividing line to form two isosceles right triangles with two right angle sides having a length of h/2. That is, a half of the height of the watermark region is used as the base and height of the first equilateral right triangle region M1 and the second equilateral right triangle region N1, the height of the first equilateral right triangle region is superposed with the side L of the watermark region, the base of the first equilateral right triangle region is superposed with the dividing line, the height of the second equilateral right triangle region is superposed with the side R of the watermark region and the base of the second equilateral right triangle region is superposed with the dividing line.

In step 204: the pixel value of each pixel in the first rectangle corresponding to the coordinate on the side T of the stuffing region is replaced by the pixel value of the pixel corresponding to the coordinate of the side T of the rectangle of the stuffing region.

As shown in FIG. 3, the top half region of the region R1 is stuffed using the pixel values on the side T of the stuffing region R1_1. A specific operation is that: the pixel value of each column in the top half region of R1 is replaced by the pixel value at the same position of the abscissa on the side T of R1_1.

In the step, the edge region acquired by dividing the first rectangle and the second rectangle is not limited to a triangle, and may also be other geometrical shape like a trapezoid, a sector, or the like, and the present disclosure is not limited to this.

In step 205: pixels on the side of the stuffing region corresponding to the wide side and the long side of the watermark region are used to stuff the edge regions in the first rectangle.

In the embodiment of the present disclosure, for each pixel in the first edge region, i.e., the first equilateral right triangle region M1, the pixel value of the pixel at the corresponding point of the coordinate on the side T of the stuffing region is acquired as a first pixel value, the pixel value of the pixel at the corresponding point of the coordinate on the side L of the stuffing region is acquired as a second pixel value, and the average of the first pixel value and the second pixel value is used as the pixel value of the pixel.

In the step, because the first equilateral right triangle is located in the first rectangle, while the first rectangle is already stuffed by the pixel value on the side T of the stuffing region, i.e., the pixel value in the first equilateral right triangle region is the pixel value on the side T of the stuffing region; therefore, the pixel value of each pixel in the first equilateral right triangle region may be read out firstly herein while stuffing the first equilateral right triangle, and then the pixel value is averaged with the pixel value of the pixel corresponding to the coordinate on the side L of the stuffing region to update the pixel value of the pixel.

In the embodiment of the present disclosure, for each pixel in the second edge region, i.e., the second equilateral right triangle region N1, the pixel value of the pixel at the corresponding point of the coordinate on the side T of the stuffing region is acquired as a third pixel value, the pixel value of the pixel at the corresponding point of the coordinate on the side R of the stuffing region is acquired as a fourth pixel value, and the average of the third pixel value and the fourth pixel value is used as the pixel value of the pixel.

In the step, because the second equilateral right triangle is located in the first rectangle, while the first rectangle is already stuffed by the pixel value on the side T of the stuffing region, i.e., the pixel value in the first equilateral right triangle region is the pixel value on the side T of the stuffing region; therefore, the pixel value of each pixel in the second equilateral right triangle region may be read out firstly herein while stuffing the second equilateral right triangle, and then the pixel value is averaged with the pixel value of the pixel corresponding to the coordinate on the side R of the stuffing region to update the pixel value of the pixel.

As shown in FIG. 3, the geometrical center of the watermark region is taken as a circle center to establish a rectangular plane coordinate system. The two sides of the top half region are two triangle shadow regions with a width of h/2; for the region M1, the average of the value of the pixel identical to the ordinate of the current pixel on the left side L of R1_1 and the value of the pixel identical to the abscissa of the current pixel on the top side T is used to replace the current pixel value; for the region N1, the average of the value of the pixel identical to the ordinate of the current pixel on the right side R of R1_1 and the value of the pixel identical to the abscissa of the current pixel on the top side T is used to replace the current pixel value.

The calculating process of stuffing in the region M1 is as shown in a formula 1

P(x,y)=(Ly+Tx)/2 formula 1

In formula 1, Ly is the pixel value on the corresponding side L when the ordinate is y, and Tx is the pixel value on the corresponding side T when the abscissa is x, wherein −w/2≦x≦−w/2+h/2&&0≦y≦h/2.

The calculating process of stuffing in the region N1 is as shown in a formula 2

P(x,y)=(Ry+Tx)/2 formula 2

In formula 2, Ry is the pixel value on the corresponding side R when the ordinate is y, and Tx is the pixel value on the corresponding side T when the abscissa is x, wherein w/2−h/2≦x≦w/2&& 0≦y≦h/2.

In step 206: the pixel value of each pixel in the second rectangle corresponding to the coordinate on the side B of the stuffing region is replaced by the pixel value of the pixel corresponding to the coordinate of the side B of the rectangle of the stuffing region.

As shown in FIG. 3, the bottom half region of the region R1 is stuffed using the pixel values on the side B of the stuffing region R1_1. A specific operation is that: the pixel value of each column in the bottom half region of R1 is replaced by the pixel value at the same position of the abscissa on the side B of R1_1 excluding the triangle shadow regions.

In step 207: pixels on the side of the stuffing region corresponding to the wide side and the long side of the watermark region are used to stuff the edge regions in the second rectangle.

In the embodiment of the present disclosure, for each pixel in the third edge region, i.e., the first equilateral right triangle region M2, the pixel value of the pixel at the corresponding point of the coordinate on the side B of the stuffing region is acquired as a fifth pixel value, the pixel value of the pixel at the corresponding point of the coordinate on the side L of the stuffing region is acquired as a sixth pixel value, and the average of the fifth pixel value and the sixth pixel value is used as the pixel value of the pixel.

In the step, because the third equilateral right triangle is located in the second rectangle, while the second rectangle is already stuffed by the pixel value on the side B of the stuffing region, i.e., the pixel value in the third equilateral right triangle region is the pixel value on the side B of the stuffing region; therefore, the pixel value of each pixel in the third equilateral right triangle region may be read out firstly herein while stuffing the third equilateral right triangle, and then the pixel value is averaged with the pixel value of the pixel corresponding to the coordinate on the side L of the stuffing region to update the pixel value of the pixel.

In the embodiment of the present disclosure, for each pixel in the fourth edge region, i.e., the fourth equilateral right triangle region N2, the pixel value of the pixel at the corresponding point of the coordinate on the side B of the stuffing region is acquired as a seventh pixel value, the pixel value of the pixel at the corresponding point of the coordinate on the side R of the stuffing region is acquired as an eighth pixel value, and the average of the seventh pixel value and the eighth pixel value is used as the pixel value of the pixel.

In the step, because the fourth equilateral right triangle is located in the second rectangle, while the second rectangle is already stuffed by the pixel value on the side B of the stuffing region, i.e., the pixel value in the fourth equilateral right triangle region is the pixel value on the side B of the stuffing region; therefore, the pixel value of each pixel in the fourth equilateral right triangle region may be read out firstly herein while stuffing the fourth equilateral right triangle, and then the pixel value is averaged with the pixel value of the pixel corresponding to the coordinate on the side R of the stuffing region to update the pixel value of the pixel.

As shown in FIG. 3, the geometrical center of the watermark region is taken as a circle center to establish a rectangular plane coordinate system. The two sides of the bottom half region are two triangle shadow regions with a width of h/2; for the region M2, the average of the value of the pixel identical to the ordinate of the current pixel on the left side L of R1_1 and the value of the pixel identical to the abscissa of the current pixel on the bottom side B is used to replace the current pixel value; for the region N2, the average of the value of the pixel identical to the ordinate of the current pixel on the right side R of R1_1 and the value of the pixel identical to the abscissa of the current pixel on the bottom side B is used to replace the current pixel value.

The calculating process of stuffing in the region N2 is as shown in a formula 3

P(x,y)=(Ly+Bx)/2 formula 3

In formula 3, Ly is the pixel value on the corresponding side L when the ordinate is y, and Bx is the pixel value on the corresponding side B when the abscissa is x, wherein −w/2≦x≦−w/2+h/2&&−h/2≦y≦0.

The calculating process of stuffing in the region N2 is as shown in a formula 4

P(x,y)=(Ry+Bx)/2 formula 4

In formula 3, Ry is the pixel value on the corresponding side R when the ordinate is y, and Bx is the pixel value on the corresponding side B when the abscissa is x, wherein w/2−h/2≦x≦w/2&&−h/2≦y≦0.

A method of stuffing the first equilateral right triangle region M1, the second equilateral right triangle region N1, the third equilateral right triangle region M2 and the fourth equilateral right triangle region N2 firstly and then stuffing the watermark region excluding the above four equilateral right triangle regions may also be adopted in step 203, step 204, step 205 and step 206 of the second embodiment of the present disclosure as above-mentioned steps, but the stuffing sequence of the embodiment of the present disclosure is not limited to this.

### Third Embodiment

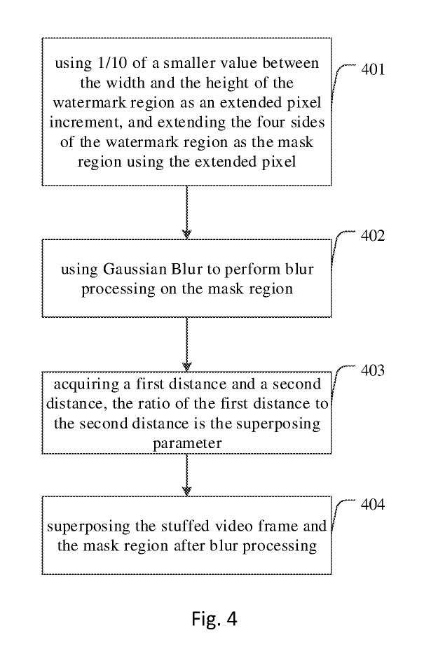

As shown in FIG. 4, a watermark expansion region in the video frame is selected, all the pixels inside the watermark expansion region are copied, and a region formed by the pixels copied is regard as a mask region, wherein the watermark expansion region is selected by externally extending the four sides of the watermark region to a first pixel range, which further includes the following steps.

In step 401: 1/N of a smaller value between the width and the height of the watermark region is used as the first pixel range, and the four sides of the watermark region are extended as the watermark expansion region using the first pixel range, wherein N is a positive integer and the first pixel range is assurable greater than 1.

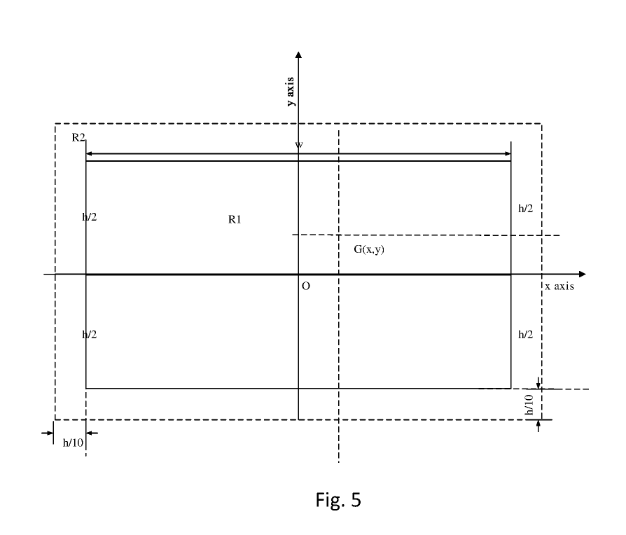

As shown in FIG. 5, after the watermark region R1 is selected, the rectangle region of the watermark region R1 is externally extended to a certain range to form a new rectangle region as the watermark expansion region, and all the pixels inside the watermark expansion region are copied to form a new region as the mask region. In the embodiment of the present disclosure, for the visual effects, the extending range is that the first pixel range selected, is 1/10 of the smaller value between the width and the height of the watermark region.

In step 402: Gaussian Blur is used to perform blur processing on the mask region, wherein a blur effect is smoother when the radius of the Gaussian Blur is larger.

Gaussian Blur uses normal distribution (i.e. “Gaussian distribution”) for image processing, and the value of each pixel in the “central point” of a Gaussian template is replaced by the average value of surrounding pixels, i.e., the average value of the “surrounding pixels” is used as the value of the “central point.” This is a kind of “smoothing” on the aspect of values, and is equivalent to that a “blur” effect is produced and the details of the “central point” are lost on the aspect of graphs.

Apparently, the “blur effect” is stronger when the neighborhood value range of the Gaussian template is larger while calculating the average value. Because the images are all successive, the relationship between adjacent points is closer while the relationship between remote points is estranged. Therefore, the calculating the average value herein refers to calculating the weighted average. Normal distribution refers to a bell-shaped curve, wherein the value of the point close to the center is larger while the value of the point remote from the center is smaller, i.e., the weight of the point close to the center is larger, and the weight of the point remote from the center is smaller.

The mask region after blur processing is used as R2. In order to implement preferable blur effect, a blur radius is 10 in the embodiment, wherein the Gauss formula for calculating the weighted average weight is as shown in formula 5:

$$G ( x , y ) = \frac{1}{2 π σ} {e}^{- \frac{{x}^{2} + {y}^{2}}{2 {σ}^{2}}} \qquad formula 5$$

In formula 5, x²+y²=r², wherein r is a blur radius, i.e., the neighborhood size of the Gaussian template selected, x is the difference between the abscissa of a pixel away from the current blurred pixel by the blur radius and the abscissa of the current blurred pixel, and y is the difference between the ordinate of a pixel away from the current blurred pixel by the blur radius and the ordinate of the current blurred pixel; wherein, a is a normal distribution standard deviation and usually σ=1. The weight of the pixels surrounding the current pixel covered by the Gaussian template during the weighted average can be calculated through formula 5.

In step 403: the distance from a current pixel in the mask region to the center of the rectangle of the mask region is used as a first distance, the distance from a point of intersection to the center of the rectangle is taken as a second distance, and the ratio of the first distance to the second distance is used as the superposing parameter, wherein the point of intersection is a point of intersection between a straight line passing through the center of the rectangle and passing through the current pixel and the rectangle boundary of the mask region.

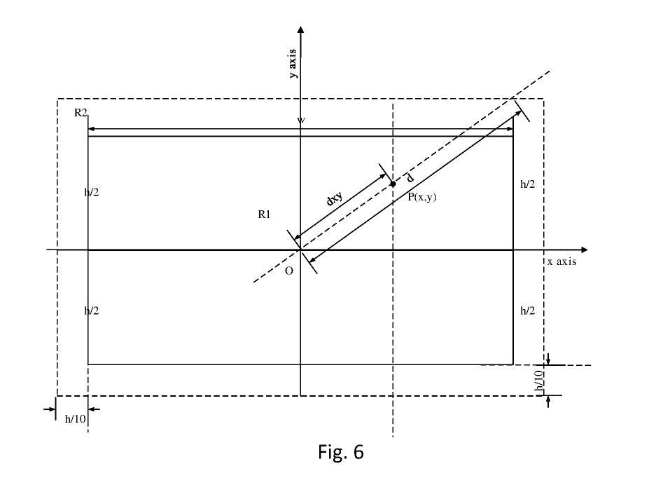

As shown in FIG. 6, the position of the current pixel in the mask region is P(x, y), a straight line is drawn by passing through the center O of the mask region and the point P, and the straight line will produce a point of intersection with the four sides of the rectangle of the mask region. The distance from the point P to the center of the rectangle is d_{xy}, and the distance from the point of intersection to the center of the rectangle is d, then a calculating formula for the superposing parameter is as shown in formula 6:

q=d_{xy}/d formula 6

In formula 6, 0≦q≦1.

In step 404: the superposing the stuffed video frame and the mask region after blur processing further includes:

superposing the mask region after blur processing to the corresponding position of the stuffed video frame according to the position of the watermark expansion region in the video frame, the size of the mask region after blur processing being used as a benchmark for the size of superposing, using the integer power of a superposing parameter as a first weight, and multiplying the first weight with the pixel value in the stuffed video frame as a first superposing item; and

subtracting the first weight from 1 as a second weight, multiplying the second weight with the pixel value of the mask region after blur processing as a second superposing item, and add the first superposing item with the second superposing item to acquire a new pixel value to replace the pixel value of the watermark stuffing region, wherein the addition process is performed with respect to the pixels having same position coordinates in the stuffed video frame and the mask region processed, and the superposing parameter is calculated according to the distance from the pixel needed to be superposed at the current position of the mask region to the central point of the mask region.

During the superposing process, because the region R1 is smaller than the region R2, the size of superposing is based on the size of the region R2 finally. It is given that the pixels of the region R1 and the surrounding pixels thereof are P_{R1}, and the pixel of the region R2 is P_{R2}. A superposing formula is as shown in formula 7:

y=q^{m}*P_{R1}+(1−q^{m})*P_{R2} formula 7

In formula 7, q is the superposing parameter, q^{m} is the first weight, 1−q^{m} is the second weight, and y is the new pixel value acquired after superposing.

Wherein, the value of in is set according to the superposing effect. In the embodiment, the superposing effect is optimal when m=10. Through superposing, smooth transition between the region containing watermarks and the surrounding region is implemented.

### Fourth Embodiment

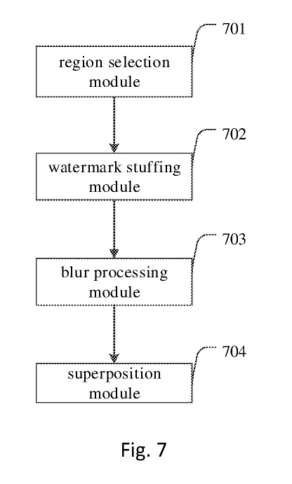

As shown in FIG. 7, a device for removing video watermarks according to the embodiment of the present disclosure includes the following modules: a region selection module 701, a watermark stuffing module 702, a blur processing module 703 and a superposition module 704, wherein:

the region selection module 7501 is configured to select a rectangle region containing watermarks in a video frame as a watermark region is configured to select a watermark expansion region in the video frame and copy all the pixels inside the watermark expansion region, and regard a region formed by the pixels copied as a mask region, wherein the watermark expansion region is selected by externally extending the four sides of the watermark region to a first pixel range;

the region selection module 701 is further configured to use the height of the watermark region as the height of the watermark region, upwards extend the side T of the watermark region to a first quantity and downwards extend the side B of the watermark region to a first quantity to acquire the stuffing region in the meanwhile; use the width of the watermark region as the width of the watermark region, extend the side L of the watermark region to the left to a first quantity and extend the side R of the watermark region to the right to a first quantity to acquire the stuffing region in the meanwhile; and

use a dividing line to divide the watermark region into two portions on the horizontal direction which are a first rectangle in the top and a second rectangle in the bottom respectively, wherein the heights of the first rectangle and the second rectangle are equal and are a half of the height of the watermark region.

The watermark stuffing module 702 is configured to externally extend the four sides of the watermark region to a second pixel range to form a stuffing region in the video frame, and use pixel values on the four sides of the stuffing region to stuff all the regions inside the watermark region to form a stuffed video frame;

the watermark stuffing module 702 is also configured to use the pixel values of columns corresponding to the abscissa of the side T of the rectangle of the stuffing region to replace the pixel value of each column of the first rectangle, wherein:

for each pixel in a first equilateral right triangle region, the pixel value of the abscissa of the pixel at the corresponding point of the side T of the stuffing region is acquired as a first pixel value, the pixel value of the ordinate of the pixel at the corresponding point of the side L of the stuffing region is acquired as a second pixel value, and the average of the first pixel value and the second pixel value is used as the pixel value of the pixel;

for each pixel in a second equilateral right triangle region, the pixel value of the abscissa of the pixel at the corresponding point of the side T of the stuffing region is acquired as a third pixel value, the pixel value of the ordinate of the pixel at the corresponding point of the side R of the stuffing region is acquired as a fourth pixel value, and the average of the third pixel value and the fourth pixel value is used as the pixel value of the pixel;

wherein, a half of the height of the watermark region is used as the base and height of the first equilateral right triangle region and the second equilateral right triangle region in the first rectangle, the height of the first equilateral right triangle region is superposed with the left side of the watermark region, the base of the first equilateral right triangle region is superposed with the dividing line, the height of the second equilateral right triangle region is superposed with the right side of the watermark region, and the base of the second equilateral right triangle region is superposed with the dividing line;

the watermark stuffing module 702 is also configured to use the pixel values of columns corresponding to the abscissa of the side B of the rectangle of the stuffing region to replace the pixel value of each column of the second rectangle, which further includes:

for each pixel in a third equilateral right triangle region, the pixel value of the abscissa of the pixel at the corresponding point of the side B of the stuffing region is acquired as a fifth pixel value, the pixel value of the ordinate of the pixel at the corresponding point of the side L of the stuffing region is acquired as a sixth pixel value, and the average of the fifth pixel value and the sixth pixel value is used as the pixel value of the pixel;

for each pixel in a fourth equilateral right triangle region, the pixel value of the abscissa of the pixel at the corresponding point of the side B of the stuffing region is acquired as a seventh pixel value, the pixel value of the ordinate of the pixel at the corresponding point of the side R of the stuffing region is acquired as an eighth pixel value, and the average of the seventh pixel value and the eighth pixel value is used as the pixel value of the pixel;

wherein, a half of the height of the watermark region is used as the base and height of the third equilateral right triangle region and the fourth equilateral right triangle region in the second rectangle, the height of the third equilateral right triangle region is superposed with the left side of the watermark region, the base of the third equilateral right triangle region is superposed with the dividing line, the height of the fourth equilateral right triangle region is superposed with the right side of the watermark region, and the base of the fourth equilateral right triangle region is superposed with the dividing line.

The blur processing module 703 is configured to perform blur processing on the mask region; and

use Gaussian Blur to perform blur processing on the mask region, wherein a blur effect is smoother when the radius of the Gaussian Blur is larger.

The superposition module 704 is configured to superpose the mask region after blur processing to the corresponding position of the stuffed video frame according to the position of the watermark expansion region in the video frame.

The superposition module 704 is further configured to superpose the watermark region and the mask region, the size of the mask region being used as a benchmark for the size of superposing, use the integer power of a first superposing parameter as a first weight, and multiply the first weight with the pixel value in the stuffed video frame as a first superposing item; use the size of the mask region after blur processing as a benchmark for the size of superposing, using the integer power of a first superposing parameter as a first weight, and multiply the first weight with the pixel value in the stuffed video frame as a first superposing item; and

subtract the first weight from 1 as a second weight, multiply the second weight with the pixel value of the mask region after blur processing as a second superposing item, and add the first superposing item with the second superposing item to acquire a new pixel value to replace the pixel value of the watermark stuffing region, wherein the addition process is performed with respect to the pixels having same position coordinates in the stuffed video frame and the mask region processed, and the first superposing parameter and the second superposing parameter are calculated according to the distance from the pixel needed to be superposed at the current position of the mask region to the central point of the mask region.

### Disclosure Example

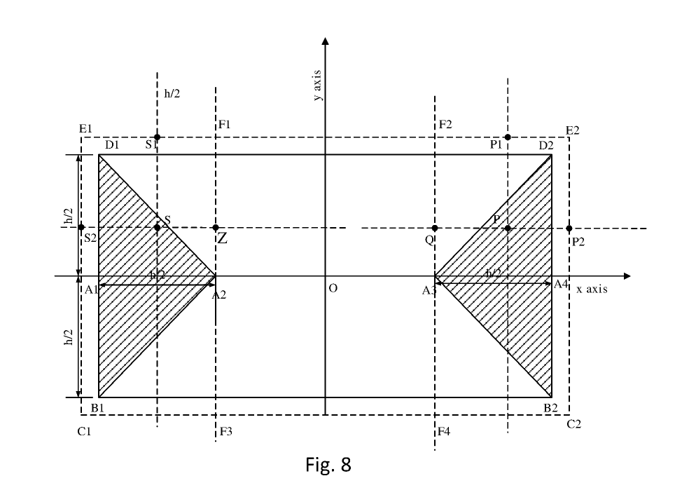

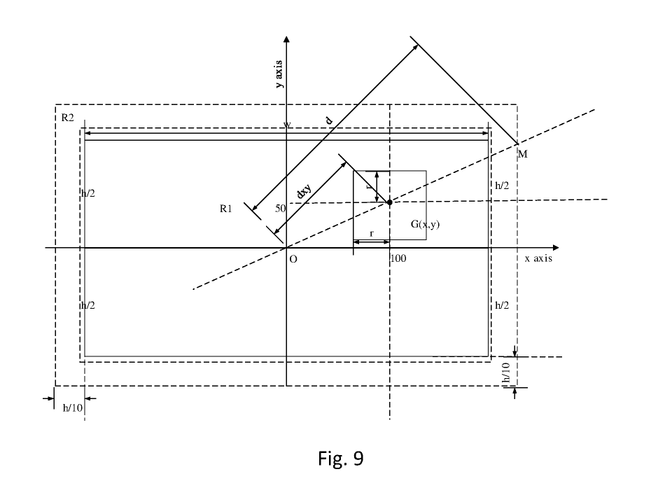

With reference to FIG. 8 and FIG. 9, the embodiment of the present disclosure will be further elaborated in the embodiment with reference to the practical disclosure scenario. In the embodiment, it is provided that the pixel size of the watermark region is 400*200.

A rectangle B1D1D2B2 is the region containing watermarks in the video frame selected, i.e., the watermark region.

In the watermark region, the minimum value of the length and width is 200; therefore, 1/10 of the minimum value 200 (i.e., 20) is used as a first pixel range for extending.

The four sides D1D2, B1D1, B1B2 and B2D2 are externally extended to a pixel of 20 respectively on the basis of the watermark region to form a new region C1E1E2C2, i.e., the watermark expansion region, wherein the size of the region is 440*240.

All the pixels inside the watermark expansion region are copied from the original video frame, and a new region formed by the pixels copied is regard as a mask region, wherein the size of the mask region is 440*240.

The four sides D1D2, B1D1, B1B2 and B2D2 are externally extended to a pixel respectively on the basis of the watermark region to form a new region C1C2E1E2, i.e., the stuffing region, wherein the size of the stuffing region is 402*202.

In FIG. 8, A1A4 is a dividing line on the width direction of the watermark region, which divides the watermark region into a top portion and a bottom portion, wherein the top A1 D1D2 A4 is a first rectangle, and the bottom B1A1A4 B2 is a second rectangle. Wherein, A1D1=A1B1=h/2.

The region A2D1D2 A3 is stuffed using the pixel value on the side E1E2, i.e., the pixel value of each column in A2D1D2 A3 is replaced by the pixel value on E1E2 equal to the abscissa thereof. For example, the pixel value of a point Q in FIG. 8 is replaced by the pixel value of a point F2 equal to the abscissa thereof.

In FIG. 8, the triangle shadow portion A1A2D1 of the first rectangle is replaced by the average of the pixel values of points corresponding to the abscissa and ordinate needing to stuff pixel values presently on side C1E1 and side E1E2. In FIG. 8, the pixel value of a point S is replaced by the average of the pixel value of a point S1 identical to the abscissa thereof on the top side E1E2 in the stuffing region and the pixel value of a point S2 identical to the ordinate thereof on the left side C1E1 in the stuffing region.

The triangle shadow portion A3A4D2 of the first rectangle is replaced by the average of the pixel values of points corresponding to the abscissa and ordinate needing to stuff pixel values presently on side C2E2 and side E1E2. In FIG. 8, the pixel value of a point P is replaced by the average of the pixel value of a point P1 identical to the abscissa thereof on the top side E1E2 in the stuffing region and the pixel value of a point P2 identical to the ordinate thereof on the right side C2E2 in the stuffing region.

For the second rectangle, the stuffing method is similar to the first rectangle, while the difference is that the lower side C1 C2 of the stuffing region is used to replace the top side E1E2 during the calculating process of the top half region, and will not be elaborated herein.

In the embodiment of the present disclosure, the radius of the Gaussian Blur is set as 10, and the optimal blur effect can be achieved at this moment. As shown in FIG. 9, the coordinates of a point G are (100, 50) for forming a two-dimensional Gaussian template that uses G(100, 50) as the center and uses 10 as the radius, wherein the pixel value of G is the average value of all the pixels in the two-dimensional Gaussian template.

As shown in FIG. 9, OG=dxy, and OM=d, then the superposing parameter q=dxy/d. In the embodiment, the superposing effect is optimal when the tenth power of the superposing parameter is taken as the first weight. The second weight is acquired by subtracting the first weight from 1.

The stuffed video frame is superposed with the mask region after blur processing using the size of the mask region processed as a benchmark. The coordinates of the point Q in FIG. 8 are Q(100, 50) and the coordinates of the point G in FIG. 9 are G(100, 50); therefore, when superposing the two regions, the pixels having the same coordinates are superposed, i.e., multiplying the first weight by the pixel value of the point Q plus multiplying the second weight by the pixel value of the point G is used as a new pixel value to replace the pixel value of the coordinate position in the watermark region.

The device embodiments described above are only exemplary. A part or all of the modules may be selected according to an actual requirement to achieve the objectives of the solutions in the embodiments. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art may be implemented in the form of a software product. The computer software product may be stored in a storage medium such as a ROM/RAM, a diskette, an optical disk or the like, and includes several instructions for instructing a computer device (which may be a personal computer, a server, or a network device so on) to execute the method according to each embodiment or some parts of the embodiments.

It should be finally noted that the above embodiments are only configured to explain the technical solutions of the present disclosure, but are not intended to limit the present disclosure. Although the present disclosure has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the technical solutions of each embodiment of the present disclosure.

What is claimed is:

1. A method for removing video watermarks, comprising:
selecting a rectangle region containing watermarks in a video frame as a watermark region and selecting a watermark expansion region, wherein the watermark expansion region is selected by externally extending the four sides of the watermark region to a first pixel range;
copying all the pixels inside the watermark expansion region, regarding a region formed by the pixels copied as a mask region, and performing blur processing on the mask region;
externally extending the four sides of the watermark region to a second pixel range to form a stuffing region in the video frame, and using pixel values on the four sides of the stuffing region to stuff all the regions inside the watermark region to form a stuffed video frame, wherein the second pixel range is less than the first pixel range; and
superposing the mask region after blur processing to the corresponding position of the stuffed video frame according to the position of the watermark expansion region in the video frame.

2. The method for removing video watermarks according to claim 1, wherein,
the using the pixel values on the four sides of the stuffing region to stuff all the regions inside the watermark region to form the stuffed video frame further comprises:
using a dividing line to divide the watermark region into two new rectangles on the width direction which are a first rectangle and a second rectangle respectively, wherein the widths of the first rectangle and the second rectangle are equal to a half of the width of the watermark region;
dividing the first rectangle and the second rectangle into two identical edge regions and a middle region along the length direction, wherein each of the edge regions has a side superposed with sides of the watermark region with different widths respectively, and the middle region has a side superposed with the long side of the watermark region; and
using pixels on the side of the stuffing region corresponding to the wide side and the long side of the watermark region to stuff the edge regions, and using pixels on the side of the stuffing region corresponding to the long side of the watermark region to stuff the middle region.

3. The method for removing video watermarks according to claim 1, wherein, the watermark expansion region selected by externally extending the four sides of the watermark region to the first pixel range further comprises:
using 1/N of a smaller value between the width and the height of the watermark region as the first pixel range, and extending the four sides of the watermark region as the mask region using the first pixel range, wherein N is a positive integer and assures that the first pixel range is greater than 1.

4. The method for removing video watermarks according to claim 1, wherein, the performing blur processing on the mask region further comprises:
using Gaussian Blur to perform blur processing on the mask region, wherein a blur effect is smoother when the radius of the Gaussian Blur is larger.

5. The method for removing video watermarks according to claim 1, wherein, the superposing the mask region after blur processing to the corresponding position of the stuffed video frame according to the position of the watermark expansion region in the video frame further comprises:
using the size of the mask region after blur processing as a benchmark for the size of superposing, using the integer power of a superposing parameter as a first weight, and multiplying the first weight with the pixel value in the stuffed video frame as a first superposing item; and
subtracting the first weight from 1 as a second weight, multiplying the second weight with the pixel value of the mask region after blur processing as a second superposing item, and adding the superposing item with the second superposing item to acquire a new pixel value to replace the pixel value of the watermark stuffing region, wherein the addition process is performed with respect to the pixels having same position coordinates in the stuffed video frame and the mask region processed, and the superposing parameter is calculated according to the distance from the pixel needed to be superposed at the current position of the mask region to the central point of the mask region.

6. The method for removing video watermarks according to claim 5, wherein, the superposing parameter calculated according to the distance from the pixel needed to be superposed at the current position of the mask region to the central point of the mask region further comprises:
using the distance from a current pixel in the mask region to the center of the rectangle of the mask region as a first distance, taking the distance from a point of intersection to the center of the rectangle as a second distance, and using the ratio of the first distance to the second distance as the superposing parameter, wherein the point of intersection is a point of intersection between a straight line passing through the center of the rectangle and passing through the current pixel and the rectangle boundary of the mask region.

7. A computer-readable record medium recording a program configured to conduct the method according to claim 1.

8. A device for removing video watermarks, comprising:
at least one processor; and
a memory communicably connected with the at least one processor for storing instructions executable by the at least one processor, wherein execution of the instructions by the at least one processor causes the at least one processor to:
select a rectangle region containing watermarks in a video frame as a watermark region and select a watermark expansion region in the video frame and copy all the pixels inside the watermark expansion region, and regard a region formed by the pixels copied as a mask region, wherein the watermark expansion region is selected by externally extending the four sides of the watermark region to a first pixel range;
externally extend the four sides of the watermark region to a second pixel range to form a stuffing region in the video frame;
use pixel values on the four sides of the stuffing region to stuff all the regions inside the watermark region to form a stuffed video frame;
perform blur processing on the mask region; and
superpose the mask region after blur processing to the corresponding position of the stuffed video frame according to the position of the watermark expansion region in the video frame.

9. The device for removing video watermarks according to claim 8, wherein,
the at least one processor is further configured to use a dividing line to divide the watermark region into two new rectangles on the width direction which are a first rectangle and a second rectangle respectively, wherein the widths of the first rectangle and the second rectangle are equal to a half of the width of the watermark region; and
the at least one processor is also configured to divide the first rectangle and the second rectangle into two identical edge regions and a middle region along the length direction, wherein each of the edge regions has a side superposed with sides of the watermark region with different widths respectively, and the middle region has a side superposed with the long side of the watermark region; use pixels on the side of the stuffing region corresponding to the wide side and the long side of the watermark region to stuff the edge regions, and use pixels on the side of the stuffing region corresponding to the long side of the watermark region to stuff the middle region.

10. The device for removing video watermarks according to claim 8, wherein,
the at least one processor is also configured to use Gaussian Blur to perform blur processing on the mask region, wherein a blur effect is smoother when the radius of the Gaussian Blur is larger.

11. The device for removing video watermarks according to claim 8, wherein,
the at least one processor is further configured to superpose the watermark region and the mask region, the size of the mask region after blur processing being used as a benchmark for the size of superposing, use the integer power of a superposing parameter as a first weight, and multiply the first weight with the pixel value in the stuffed video frame as a first superposing item; and
subtract the first weight from 1 as a second weight, multiply the second weight with the pixel value of the mask region after blur processing as a second superposing item, and add the superposing item with the second superposing item to acquire a new pixel value to replace the pixel value of the watermark stuffing region, wherein the addition process is performed with respect to the pixels having same position coordinates in the stuffed video frame and the mask region processed, and the superposing parameter is calculated according to the distance from the pixel needed to be superposed at the current position of the mask region to the central point of the mask region.
